(19) United States
(12) Patent Application Publication
(10) Pub. No.: US 2009/0249090 A1
(43) Pub. Date: Oct. 1, 2009

(54) METHOD AND APPARATUS FOR DYNAMIC POWER MANAGEMENT CONTROL USING PARALLEL BUS MANAGEMENT PROTOCOLS

(76) Inventors: Michael J. Schmitz, Fargo, ND (US); Jonathan P. Kotta, Fargo, ND (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/411,960

(22) Filed: Mar. 26, 2009

Related U.S. Application Data
(60) Provisional application No. 61/072,225, filed on Mar. 28, 2008.

(51) Int. Cl. G06F 1/04; G06F 1/00

(52) U.S. Cl. 713/300

(57) ABSTRACT

An apparatus for on-demand power management includes an I/O parallel communication master device, peripheral devices that communicate with the master along the parallel bus, and a power manager that arbitrates the parallel bus. The power manager also manages voltage regulation and clock sources to the peripheral devices, with the ability of placing the peripheral devices in an inactive state, or in any number of active states as a means to conserve energy. In some embodiments, the I/O parallel communication master device acts as if the peripheral devices are always in the highest activity state, and the power manager manages the communications to and from the peripheral devices and the power management of the peripheral devices to minimize energy consumption and reduce system latency.

### RELATED APPLICATIONS

This application claims the benefit of the filing date of U.S. Provisional Application No. 61/072,225, filed Mar. 28, 2008.

### TECHNICAL FIELD

The present invention relates generally to power management and in particular to managing voltages and frequencies supplied to peripheral devices in response to processing demands, using bus management methods as a means to assess processing demand and control dynamic voltage and frequency scaling.

### BACKGROUND

As digital electronic processing systems trend toward higher operating frequencies and smaller device geometries, power management has become increasingly important to prevent thermal overload while maintaining system performance and prolonging battery life in portable systems.

The two principal sources of power dissipation in digital logic circuits are static power dissipation and dynamic power dissipation. Static power dissipation is dependent on temperature, device technology and processing variables and is composed primarily of leakage currents. Dynamic power dissipation is the predominant loss factor in digital circuitry and is proportional to the operating clock frequency, the square of the operating voltage and the capacitive load. Capacitive load is highly dependent on device technology and processing variables, so most approaches to dynamic power management focus on frequency and voltage control.

Digital design architectures are characterized as having a master or controller interoperating with a number of devices on a shared bus. One conventional approach is to have all peripheral devices connected on a communication bus to be powered from a common power distribution system. The power management algorithms will enable or disable devices along this power distribution system as needed, in order to conserve energy from devices when they are not required for system operation. The means to enable and disable devices is controlled by software, typically by the input/output (I/O) controller of the parallel bus.

### BRIEF DESCRIPTION OF THE DRAWINGS

The present invention is illustrated by way of example, and not of limitation, in the figures of the accompanying drawings in which:

FIG. 1 illustrates a bus design with devices connected to a common parallel communication system;

FIG. 2A illustrates one embodiment of an on-demand power management system;

FIG. 2B illustrates one embodiment of on-demand power management design with an I/O controller and a peripheral device on a parallel bus;

FIG. 2C illustrates another embodiment of on-demand power management design with an I/O controller and a peripheral device on a parallel bus;

FIG. 3 illustrates one embodiment of on-demand power management design with an I/O controller and two peripheral devices on a parallel bus;

FIG. 4 illustrates one embodiment of a device communication flow; and

FIG. 5 illustrates one embodiment of phase-matching in on-demand power management.

### DETAILED DESCRIPTION

In the following description, numerous specific details are set forth such as examples of specific components, devices, methods, etc., in order to provide a thorough understanding of embodiments of the present invention. It will be apparent, however, to one skilled in the art that these specific details need not be employed to practice embodiments of the present invention. In other instances, well-known materials or methods have not been described in detail in order to avoid unnecessarily obscuring embodiments of the present invention. It should be noted that the “line” or “lines” discussed herein, that connect elements, may be single lines or multiple lines. It will also be understood by one having ordinary skill in the art that lines and/or other coupling elements may be identified by the nature of the signals they carry (e.g., a “clock line” may implicitly carry a “clock signal”) and that input and output ports may be identified by the nature of the signals they receive or transmit (e.g., “clock input” may implicitly receive a “clock signal”).

Various embodiments of on-demand power management are described, specifically improving upon a system using parallel communication structures between components. The embodiments described herein are directed at minimizing the total energy consumption of the peripheral devices. The embodiments described herein relate to a power management scheme that manages voltages and frequencies of the peripheral devices in response to processing demands, using bus management methods as a means to assess processing demand and control dynamic voltage and frequency scaling.

In one embodiment, an apparatus for on-demand power management includes an I/O parallel communication master device, peripheral devices that communicate with the master along a parallel bus, and a power manager that arbitrates the parallel bus. The power manager also manages voltage regulation and clock sources to the peripheral devices, with the ability of placing the peripheral devices in an inactive state, or in any number of active states as a means to conserve energy. In some embodiments, the I/O parallel communication master device acts as if the peripheral devices are always in the highest activity state, and the power manager manages the communications to and from the peripheral devices and the power management of the peripheral devices to minimize energy consumption and reduce system latency.

In one embodiment, a power manager is coupled to a parallel bus between an I/O controller (e.g., I/O controller of a host processing device) and multiple different types of peripheral devices. The power manager adjusts the operating voltage and/or clock frequency of the peripheral device to minimize energy consumption, depending on the operating state of operation of the peripheral device. The power manager determines the operating state of the peripheral device by monitoring the bus transactions between the I/O controller and the peripheral device to determine the current processing demand. If a particular bus transaction requires that the peripheral device be in a different operating or power state, the power manager can delay the bus transactions sent from the I/O controller until the power manager has finished adjusting the operating voltage and/or clock frequency required for the new operating state.

In one embodiment, the method includes monitoring a parallel bus to assess a processing demand for a peripheral device in a processing system. The parallel bus is sometimes referred to as a parallel communication channel. The processing demand is correlated to energy demand, which is appropriately addressed with dynamic voltage scaling and dynamic frequency scaling. The dynamic frequency scaling also includes generating a second set of one or more clock frequencies in response to the processing demand, and switching to the second set of clock frequencies from a first set of one or more clock frequencies. In one embodiment, the second set of one or more clock frequencies are phase-locked to the reference frequency and phase-matched to the first set of one or more clock frequencies. The method also includes switching from the first set of clock frequencies to the second set of clock frequencies without halting the processing system. In one embodiment, the method further includes generating a first set of one or more operating voltages in response to the processing demand, and switching from a first set of one or more operating voltages to the second set of one or more operating voltages without halting the processing system.

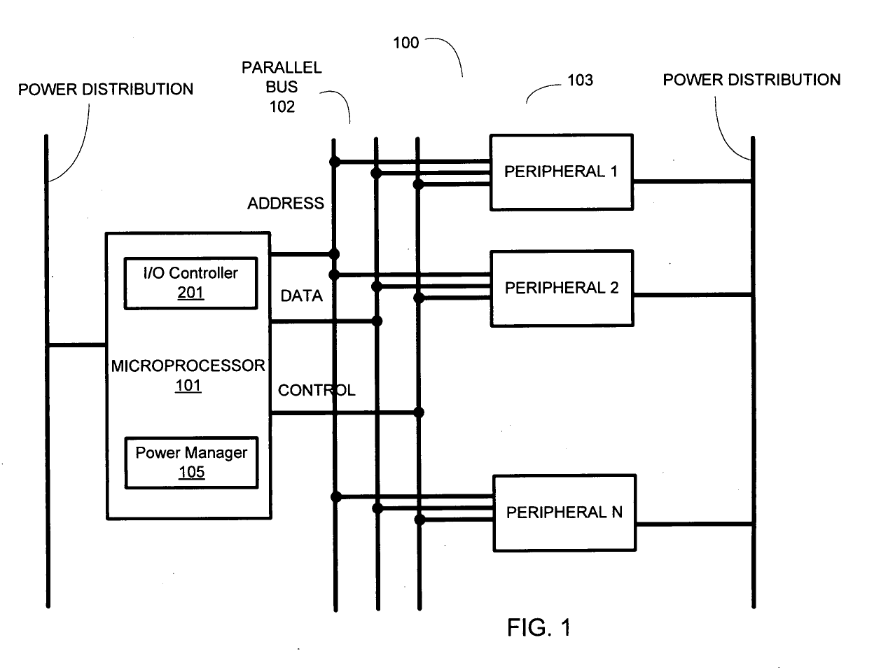

FIG. 1 illustrates one embodiment of on-demand power management in a processing system 100. Processing system 100 includes a microprocessor 101, which may be a general purpose processing device. Alternatively, the microprocessor 101 may also be a special-purpose processing device such as an application specific integrated circuit (ASIC), a field programmable gate array (FPGA), a digital signal processor (DSP) or the like. Furthermore, microprocessor 101 may be integrated with an input/output (I/O) controller. The microprocessor 101 is coupled to a parallel bus 102 which may carry system data and commands to and from microprocessor 101. The parallel bus 102 may be coupled to peripheral devices 103, which may provide input and output functions to the processing system 100. A peripheral device is a device attached to a host processing device (e.g., host computer), and whose primary functionality is dependent upon the host, and can therefore be considered as expanding the host's capabilities, while not forming part of the host's core architecture. The peripheral devices 103 may be on-chip integrated peripheral devices, such as an Ethernet device, a memory device, or the like. The peripheral device may also be other types of I/O devices, for example, displays, keyboards, wireless communication channel devices, wired communication channel devices, user input devices, printers, scanners, disk drives, tape drives, microphones, speakers, cameras, or the like. In some embodiments, the parallel bus 102 may include one or more parallel buses and the peripheral devices 103 may include one or more parallel peripheral devices.

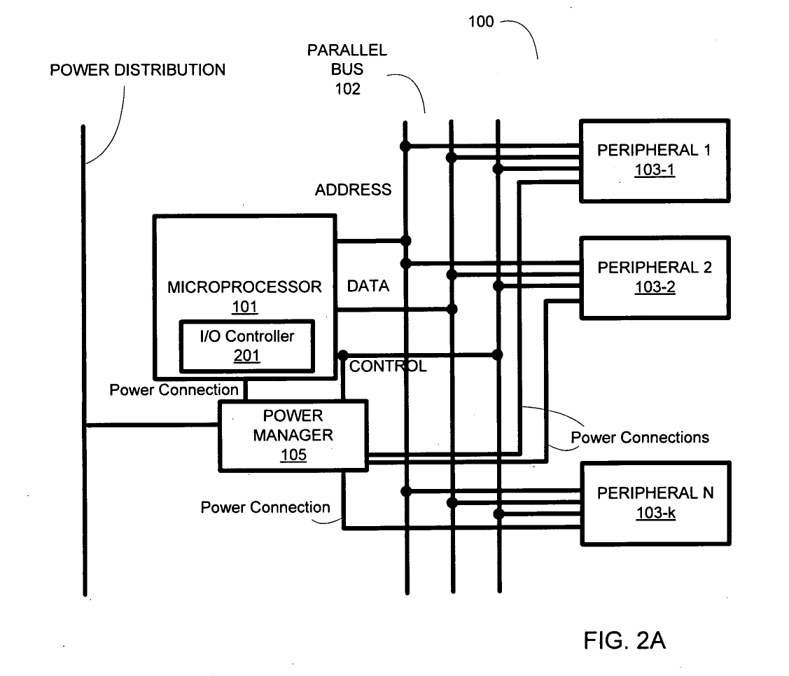

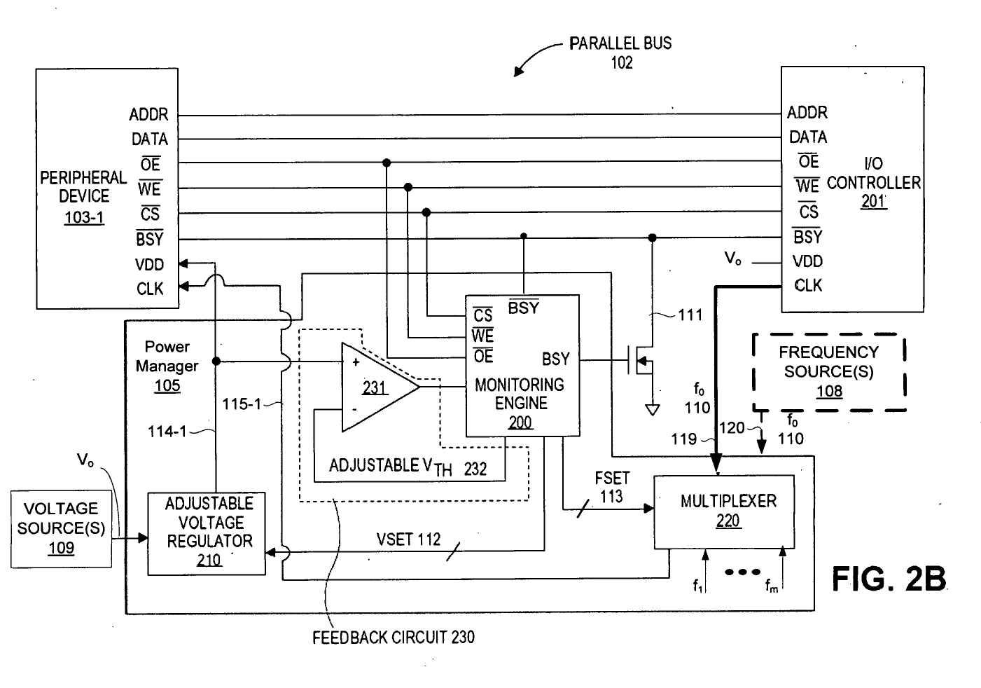

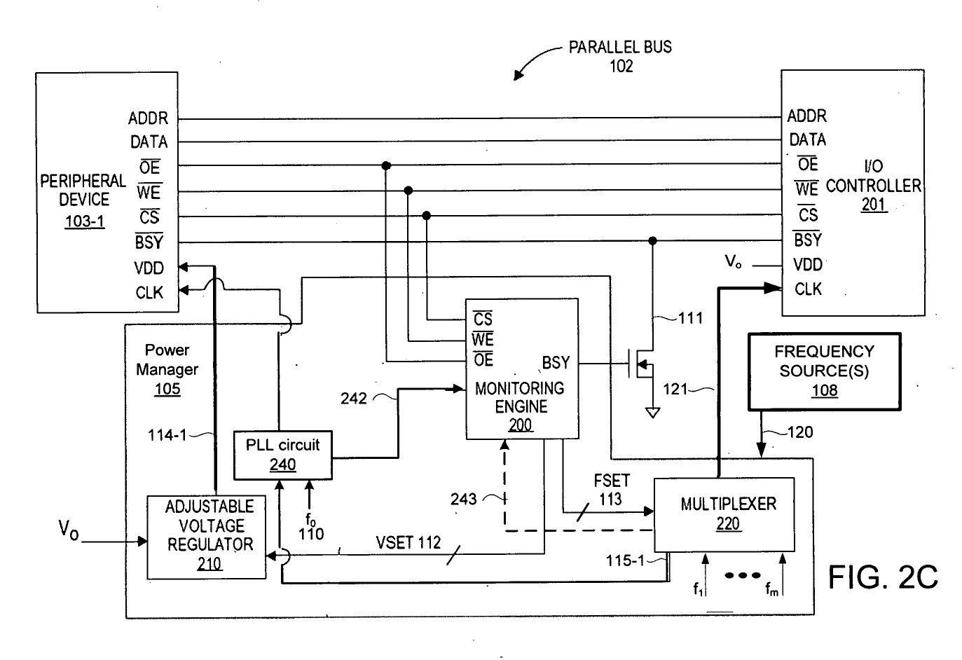

In one embodiment, the processing system 100 also includes a power manager 105 integrated with microprocessor 101, as illustrated in FIG. 1. In another embodiment, the processing system 100 includes a power manager 105, which may be a separate module distinct from microprocessor 101, as illustrated in FIG. 2A. In some embodiments, microprocessor 101 and power manager 105 reside on a common carrier substrate (such as an integrated circuit substrate). Alternatively, microprocessor 101 and power manager 105 may reside on different substrates. Referring to FIG. 2A, microprocessor 101 and the peripherals 103 do not have any explicit power connections with the power distribution. In the depicted embodiment, the power manager 105, which is coupled to the power distribution, provides power to the microprocessor 101 and/or the peripherals 103-1 through 103-k using individual power connections. Alternatively, the power connections between the power manager and the microprocessor 101 and/or the peripherals 103-1 through 103-k may be part of the control lines connected to the power manager 105. In the depicted embodiment, the power manager 105 can monitor and modify control signals on the control lines between the microprocessor 101 and the peripheral devices 103-1 through 103-k. Via parallel bus 102, power manager 105 is coupled to peripherals 103-1 through 103-k.

With reference to FIG. 2A, peripherals 103-1 through 103-k may be any type of device, component, circuit, subsystem or system capable of communicating with microprocessor 101 via parallel bus 102. For example, any of peripheral devices 103-1 through 103-k may be a single chip device such as a system on a chip, an ASIC, an FPGA, a memory chip or like device. Any of peripherals 103-1 through 103-k may also be a multi-chip module including any combination of single chip devices on a common integrated circuit substrate. Alternatively, peripherals 103-1 through 103-k may reside on one or more printed circuit boards such as, for example, a mother board, a daughter board or other type of circuit card.

FIG. 2B illustrates one embodiment of on-demand power management design with an I/O controller 201 and a peripheral device 103-1 on a parallel bus 102. The power manager 105 is coupled to the parallel bus among the peripheral device 103-1 and the I/O controller 201. The power manager 105 includes a monitoring engine 200 coupled to the parallel bus 102 to monitor bus transactions between the I/O controller 201 and the peripheral device 103-1. In one embodiment, the monitoring engine 200 determines which peripheral device is being accessed, whether the access is a write operation or a read operation, and determines the required operating voltages and clock frequencies for the peripheral devices based on the monitored bus activity. In another embodiment, the monitoring engine 200 determines the required operating voltage and clock frequency of the I/O controller 201 based on the monitored bus activity. In one embodiment, the monitoring engine 200 is a hardware state machine. In another embodiment, the monitoring engine 200 is a processing device, such as a microprocessor, with programmable software. Alternatively, the monitoring engine 200 may be implemented as software or firmware executed by a processing device.

In one embodiment, the monitoring engine 200 has knowledge of what types of peripheral devices (e.g., a memory device, an Ethernet device, a liquid crystal display (LCD), or the like) are connected to the parallel bus 102. Knowing the types of peripheral devices may help the monitoring engine 200 determine the appropriate operating voltage and clock frequency required for the peripheral based on the detected bus activity. In one embodiment, the monitoring engine 200 determines the required operating states (also referred to as power states) for the peripheral devices based on the data being transmitted by the I/O controller 201. The monitoring engine 200, using the determined operating states, adjusts the operating voltages and clock frequencies supplied to the peripheral devices to minimize energy consumption.

In one embodiment, the monitoring engine 200 monitors the bus transactions to assess a current processing demand for the peripheral device 103-1, and the monitoring engine 200 dynamically adjusts either or both operating voltage on the voltage line 114-1 and the clock frequency for the peripheral device on clock line 115-1 based on the current processing demand. The current processing demand correlates to the required operating state for the peripheral device to process the bus transaction.

In one embodiment, the monitoring engine 200 determines whether the peripheral device 103-1 is to operate in a specified operating state for one or more bus transactions. In one embodiment, the monitoring engine 200 switches the peripheral device 103-1 from a first operating state to a second operating state based on the determination. In the depicted embodiment, the monitoring engine 200 switches to the second operating state by providing a signal 112 (Vset) to adjustable voltage regulator 210 to adjust the operating voltages of the peripheral devices 103-1. The adjustable voltage regulator 210 receives an operating voltage (V₀) from voltage source(s) 109, and generates one or more operating voltages to be provided to the peripheral device 103-1. The adjustable voltage regulator 210 provides the adjusted operating voltage to the peripheral device 103-1 by way of the voltage line 114-1. Although the depicted embodiment illustrates the I/O controller 201 as being powered by the operating voltage (V₀) from the voltage source(s) 109, in another embodiment, the adjustable voltage regulator 210 can receive the operating voltage (V₀) from the voltage source(s) 109, and generate one or more voltages to provide to the I/O controller 201. Alternatively, the power manager 105 can receive multiple voltages (not illustrated) from the voltage source(s) 109, and select the appropriate voltage, for example, using a multiplexer, to provide to the respective peripheral device with the selected operating voltage. Although in the depicted embodiment, the voltage source 109 is separate from the power manager, in other embodiments, the voltage source 109 may be an output of another voltage regulator, and thus, may be integrated with the power manager 105 and reside with the power manager 105 on a common carrier substrate such as, for example, an IC die substrate, a multi-chip module substrate, or the like.

In the depicted embodiment, the monitoring engine 200 switches to the second operating state by providing a signal 113 (Fset) to a multiplexer 220 to adjust the clock frequency of the peripheral device 103-1. The clock multiplexer 220 provides the adjusted clock frequency to the peripheral device 103-1 using clock line 115-1. In one embodiment, the multiplexer 220 receives the reference frequency (f₀) 110 from the I/O controller 201 on clock line 119, and one or more clock frequencies f₁ through fₘ, which are derived from the reference frequency (f₀) 110 by the power manager 105. The multiplexer 220 receives a command or a signal from the monitoring engine 200 to select which of available frequencies to provide as a clock signal to the peripheral device 103-1 on the clock line 115-1. The one or more clock frequencies f₁ through fₘ are phase-locked to the reference frequency (f₀), and the one or more clock frequencies f₁ through fₘ may be phased-matched with one another, as described below.

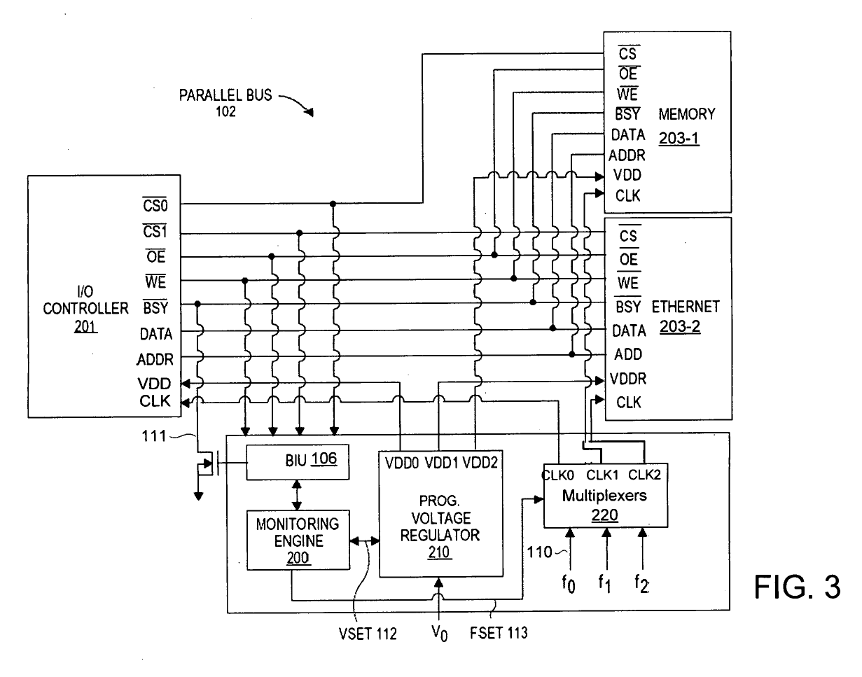

In another embodiment, the power manager 105 receives the reference frequency (f₀) 110 from the frequency source 108 on clock line 120, instead of from the from the I/O controller 201, and provides the reference frequency (f₀) to the I/O controller 201 on an input clock line (e.g., clock line 121 as illustrated in FIG. 3). In another embodiment, the multiplexer 220 receives multiple clock frequencies from one or more frequency sources, which are either derived from the reference frequency 110 (f₀) by the power manager 105 or generated external to the power manager 105.

In one embodiment, the monitoring engine 200 monitors one or more control lines on the parallel bus 102 between the I/O controller 201 and the peripheral device 103-1 to detect a data transfer request for a current bus transaction from the I/O controller 201 to the peripheral device 103-1. The monitoring engine 200 determines whether the peripheral device 103-1 is to operate in a second operating state to process the current bus transaction. The monitoring engine 200 switches the peripheral device 103-1 to operate in the second operating state to allow the peripheral device 103-1 to process the current bus transaction. The second operating state corresponds to the current processing demand for the destination peripheral device. In one embodiment, the first operating state is a lower power state than the second operating state. In another embodiment, the first operating state is a higher power state than the second operating state.

In one embodiment, the monitoring engine 200 monitors one or more of the following control lines: a chip select (CS) signal, an output enable (OE) signal, a write enable (WE) signal, or a busy (BSY) signal. For example, the I/O controller 201 asserts the CS and WE signals for the peripheral device 103-1 to indicate a data transfer request for a current bus transaction; a write operation in this case. The power manager 105 detects the asserted CS and WE signals, and provides a busy signal 111 to delay the I/O controller 201 from sending data for the bus transaction until the power manager 105 has finished adjusting either or both the operating voltage and clock frequency for the peripheral device 103-1. Alternatively, the monitoring engine 200 can monitor other types of control lines to determine whether the peripheral device 103-1 is to operate in a second operating state to process the current bus transaction.

Since it takes some non-zero time for the power manager 105 to adjust the operating voltage and clock frequency of a peripheral device, the power manager 105 can inform the I/O controller 201 that the parallel bus and/or the peripheral device is busy. In one embodiment, an open collector output of the power manager 105 is interfaced to the busy signal line in the parallel bus 102. When the power manager 105 needs to notify the I/O controller 201 to wait, the power manager 105 can pull down the busy signal. When the power manager 105 has finished adjusting the operating voltages and/or clock frequencies of the peripherals and/or I/O controller 201, the power manager 105 notifies the I/O controller 201 to resume operation by releasing the busy signal.

In one embodiment, the power manager 105 can inform the I/O controller 201 that a particular peripheral device is busy by providing a busy signal 111 on the busy signal line to pause the transmission of the bus transaction until the particular peripheral device 103-1 is ready for the bus transaction. Once the power manager 105 has finished adjusting the operating state of the peripheral device 103-1, the power manager 105 releases the busy signal 111 (e.g., de-asserting the busy signal 111), allowing the I/O controller 201 and the peripheral device 103-1 to complete the bus transaction. In the depicted embodiment, the power manager 105 is interfaced to the busy signal line via an open-collector output using a metal-oxide-semiconductor field-effect transistor (MOSFET). The open-collector MOSFET is used because the peripheral device 103-1 may also be driving the busy signal line. The busy (BSY) signal output from the monitoring engine 220 is inverted using the MOSFET for the busy ( B̅S̅Y̅) signal 111, and supplied to the I/O controller 201 and the peripheral device 103-1 on the busy signal line. In other embodiments, the monitoring engine 200 may output the busy ( B̅S̅Y̅) signal 111, allowing the monitoring engine 200 to be directly coupled to the busy signal line without being inverted. It should be noted that although some of the figures and description refer to a certain sign convention for the control signals, such as, for example, chip select bar ( C̅S̅, C̅S̅0̅ C̅S̅1̅), output enable bar ( O̅E̅), write enable bar ( W̅E̅), and busy bar ( B̅S̅Y̅), other sign conventions may be used as would be appreciated by one of ordinary skill in the art having the benefit of this disclosure.

In one embodiment, the monitoring engine 200 monitors the voltage adjustment on the voltage line 114-1 to determine when the operating voltage supplied to the peripheral device 103-1 meets or exceeds a specified voltage threshold. In one embodiment, the monitoring engine 200 uses a feedback circuit 230 to monitor the supply voltage of the peripheral device 103-1 to determine when the voltage has reached the appropriate level before releasing the parallel bus 102 (e.g., de-asserting the busy signal 111). This active monitoring of the voltage supplied to the peripheral device 103-1 enables the power manager 105 to release the parallel bus 102 sooner rather than waiting for a fixed delay. In another embodiment, the power manager 105 can use a fixed delay to allow the transition in operating voltages supplied to the peripheral device 103-1. In one embodiment, the feedback circuit 230 includes a comparator that compares the supply voltage to an adjustable voltage threshold (V_{TH}) 232, where the adjustable voltage threshold 232 is set to the minimum voltage required for normal operation to resume. Depending on the operating state of the peripheral device 103-1, which is determined by the monitoring engine 200 monitoring the bus activity, the magnitude of the adjustable voltage threshold 232 may be changed.

In the depicted embodiment, the feedback circuit 230 includes comparator 231 having a non-inverting terminal coupled to the voltage line 114-1, and an inverting terminal coupled to receive the adjustable voltage threshold (V_{TH}) 232 from the monitoring engine 220. Once the operating voltage on the voltage line 114-1 meets or exceeds the adjustable voltage threshold 232, the comparator 231 sends a signal on an output terminal to the monitoring engine 200 to indicate that the adjustable voltage threshold 232 has been met or exceeded. In response, the monitoring engine 200 can release the parallel bus 102, for example, by de-asserting the busy signal 111, to allow the I/O controller 201 and peripheral device 103-1 to complete the bus transaction. In other embodiments, the feedback circuit 230 may be implemented using other configurations, as would be appreciated by one of ordinary skill in the art having the benefit of this disclosure.

As would be appreciated by one of ordinary skill in the art, the monitoring engine 220 is coupled to the parallel bus 102 by way of a bus interface unit (BIU) (not illustrated). The BIU is the physical circuit interfaces that enable the internal bus signals of the power manager 105 to connect to the external bus 102.

In one embodiment, the I/O controller 201 is provided the operating voltage (V₀) from the voltage source 109. In another embodiment, the operating voltage is supplied to the I/O controller 201 by way of the power manager 105, such as, for example, providing the operating voltage from the adjustable voltage regulator 210 on a voltage line to the I/O controller 201 (as illustrated in FIG. 3). Alternatively, other configurations are possible as would be appreciated by one of ordinary skill in the art having the benefit of this disclosure.

FIG. 2C illustrates another embodiment of on-demand power management design with the I/O controller 201 and the peripheral device 103-1 on the parallel bus 102. The power manager 105 of FIG. 2C is similar to the power manager 105 of FIG. 2B, except instead of a voltage monitoring circuit (e.g., feedback circuit 230), the power manager 105 includes a phase-locked loop (PLL) circuit 240 to provide a feedback signal to the monitoring engine 200 regarding the switching between frequencies. In the depicted embodiment, the PLL circuit 240 compares the frequencies of two signals (e.g., reference frequency (f₀) 110 and the second clock frequency to which the monitoring engine 200 is switching) and produces an error signal which is proportional to the difference between the input frequencies. The error signal may then be low-pass filtered and used to drive a voltage-controlled oscillator (VCO) which creates an output frequency. The output frequency is fed through a frequency divider back to the input of the system, producing a negative feedback loop. If the output frequency drifts, the error signal will increase, driving the frequency of the VCO in the opposite direction so as to reduce the error. Thus the output is locked to the reference frequency (f₀) at the other input. In this embodiment, the monitoring engine 220 can switch the input frequency from the first clock frequency to the second clock frequency, and the PLL circuit 240 can output a locked signal 242 when the second clock frequency is locked with the reference frequency (f₀) 110. The locked signal 242 may be a feedback signal to the monitoring engine 220 to indicate when the PLL circuit 240 circuit is locked, indicating that the power manager 105 has switched to the second frequency for the peripheral device 103-1. In response, the monitoring engine 200 can release the parallel bus 102, for example, by de-asserting the busy signal 111, to allow the I/O controller 201 and peripheral device 103-1 to complete the bus transaction.

In another embodiment, instead of monitoring the locked signal 242 from the PLL circuit 240, the monitoring engine 220 can monitor an output signal 243 from the multiplexer 220 as a feedback signal that indicates that the action of switching from one clock frequency to another is completed. Alternatively, other configurations may be implemented to allow the monitoring engine 220 to receive feedback on the frequency switching, as would be appreciated by one of ordinary skill in the art having the benefit of this disclosure. In another embodiment, the power manger 105 of FIG. 2C includes the feedback circuit 230 described in FIG. 2B.

FIG. 3 illustrates one embodiment of on-demand power management design with an I/O controller and two peripheral devices 203-1 and 203-2 on a parallel bus 102. In this embodiment, the power manager 105 is similar to the power manager 105 of FIG. 2B, except FIG. 3 illustrates how the power manager 105 is coupled to two peripheral devices 203-1 and 203-2 on the parallel bus 102. The power manager 105 of FIG. 3 includes a BIU 106 that is coupled to the parallel bus 102 to interface. As described above with respect to FIG. 2B, the BIU 106 enables the internal bus signals of the power manager 105 to connect to the external parallel bus 102 for monitoring control signals on the parallel bus 102. Also, in the depicted embodiment, the multiplexer 220 receives the reference frequency (f₀) 110 and two frequencies (f₁ and f₂) for providing clock frequencies to the I/O controller 201 (CLK0) and the peripheral devices 203-1 and 203-2 (CLK1 and CLK2). As described above, the multiplexer 220 may receive the frequencies from an external frequency source, or alternatively, the power manager 105 can receive the reference frequency (f₀) 110 from an external frequency source, and derive one or more frequencies from the reference frequency (f₀) 110, which are phase-locked to the reference frequency (f₀) 110 and phase-matched to one another. The adjustable voltage regulator in the depicted embodiment is a programmable voltage regulator 210, and receives a command or signal (Vset) 112 from the monitoring engine 200 to select the appropriate voltage to be supplied to the peripheral devices 203-1 (VDD1) and 203-2 (VDD2). The programmable voltage regulator 210 also supplies a voltage (VDD0) to the I/O controller 201 in this depicted embodiment. Alternatively, other configurations may be implemented as would be appreciated by one of ordinary skill in the art having the benefit of this disclosure.

In the depicted embodiment, the two peripheral devices are a memory device 203-1 and an Ethernet device 203-2. Since both the memory device 203-1 and the Ethernet device 203-2 share the same parallel bus 102, the monitoring engine 200 monitors the control signals (e.g., CS0, CS1, OE, and/or WE signals) to determine which peripheral device is selected, and determine the desired operating state for the selected peripheral device. For example, the memory device 203-1 can be in an inactive state, or a lower power state, and can be switched to an active state. In one embodiment, the peripheral devices can be switched to different active states for read operations and write operations. For example, the memory device 203-1 may need to be in a higher operating state during a write operation than during a read operation, and the monitoring engine 200 can switch the memory device 203-1 to either active state based on the type of data transfer request (e.g., the CS0 and OE signals are active for a read operation to the memory device 203-1, and the CS0 and WE signals are active for a write operation to the memory device 203-1). Similarly, the monitoring device 200 can determine which operating state the Ethernet device 203-2 needs to be in for the different types of bus transactions (e.g., a read operation, a write operation, or the like). It should be noted that although the parallel peripheral devices of FIG. 3 are the memory device 203-1 and the Ethernet device 203-2, in other embodiments, other types of parallel peripheral devices may be used as would be appreciated by one of ordinary skill in the art having the benefit of this disclosure.

Like described above with respect to FIG. 2B, the power manager 105 of FIG. 3 can delay the bus transaction by asserting the busy signal 111 on the parallel bus 102, and releasing the parallel bus 102, when the particular peripheral device is ready (e.g., in the appropriate operating state for the bus transaction). In the depicted embodiment, the power manager 105 is interfaced to the busy ( B̅S̅Y̅) signal line via an open-collector output using the MOSFET, as described above with respect to FIG. 2B. In other embodiments, the monitoring engine 200 may output the busy ( B̅S̅Y̅) signal 111, allowing the monitoring engine 200 to be directly coupled to the busy signal line without being inverted.

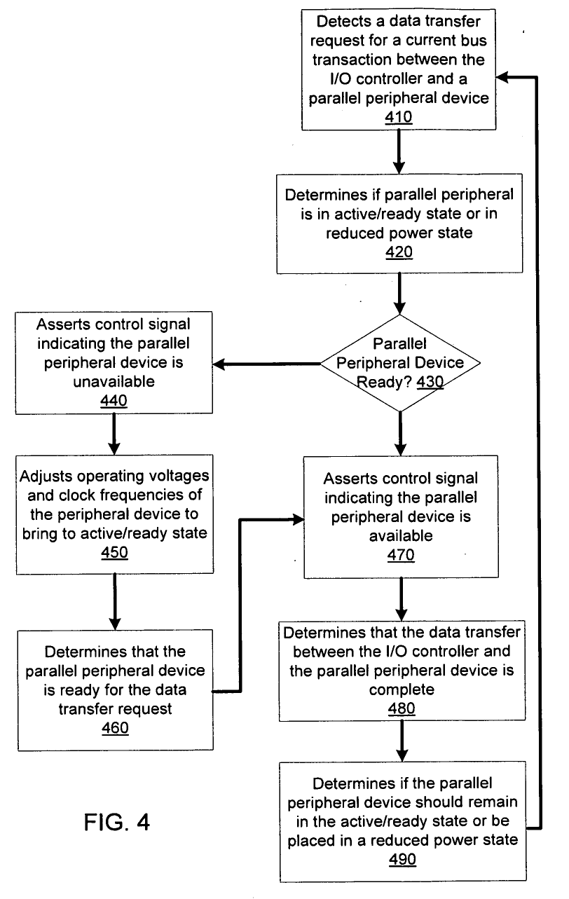

FIG. 4 illustrates one embodiment of a device communication flow. The flow may be performed by processing logic of various components in system 100 described above, such as the monitoring engine 220. Processing logic may include software, hardware, firmware, or any combination thereof. The processing system includes a parallel bus, such as the parallel bus 102 in FIGS. 1, 2A-2C, and 3. Referring to FIG. 4, the processing logic detects a data transfer request for a current bus transaction between the I/O controller and a parallel peripheral device (processing block 410) on the parallel bus. For example, the I/O controller 201 initiates a data transfer request for a read operation or a write operation with one of the parallel peripheral devices on the parallel bus, for example, by asserting a chip select signal, and an output enable signal or a write enable signal. In one embodiment, the processing logic monitors the chip select signals (e.g., CS0 and CS1) to determine which peripheral device is being accessed, and monitors the output enable and the write enable signals (e.g., OE and WE signals) to determine whether the access is a write operation or a read operation. The processing logic determines if the parallel peripheral device being accessed is in an active/ready state or in a reduced power state (processing block 420). The processing logic further determines if the parallel peripheral device is ready or not (processing block 430) for the current bus transaction, for example, by monitoring the busy signal (e.g., B̅S̅Y̅) on the busy signal line. If the parallel peripheral device is not ready, the process transitions to processing block 440. Otherwise, the process transitions to processing block 470.

At processing block 440, the processing logic asserts a control signal (e.g., busy signal 111) indicating that the parallel peripheral device is unavailable, placing the I/O controller in a wait state for the current bus transaction. The processing logic transitions the parallel peripheral device to a second operating state from the first operating state by adjusting the operating voltages and/or clock frequencies of the parallel peripheral device to bring the parallel peripheral device to the active/ready state (processing block 450). The processing logic further determines if the parallel peripheral device is ready for the current bus transaction (processing block 460). Then the process transitions to processing block 470.

At processing block 470, processing logic asserts a control signal indicating the parallel peripheral device is available (e.g., de-asserts the busy signal 111). When the parallel peripheral device is available (e.g., operating at the second operation state), the processing logic initiates a device communication flow between the I/O controller and the parallel peripheral device for the current bus transaction. The processing logic determines that the current bus transaction between the I/O controller and the parallel peripheral device is complete (processing block 480). The processing logic determines if the parallel peripheral device should remain in the active/ready state or be placed in a reduced power state (processing block 490), and if necessary, transitions the parallel peripheral device to the first operating state, or another lower-power operating state when the current bus transaction is complete or after a specified period of time. Next, the process transitions back to processing block 410.

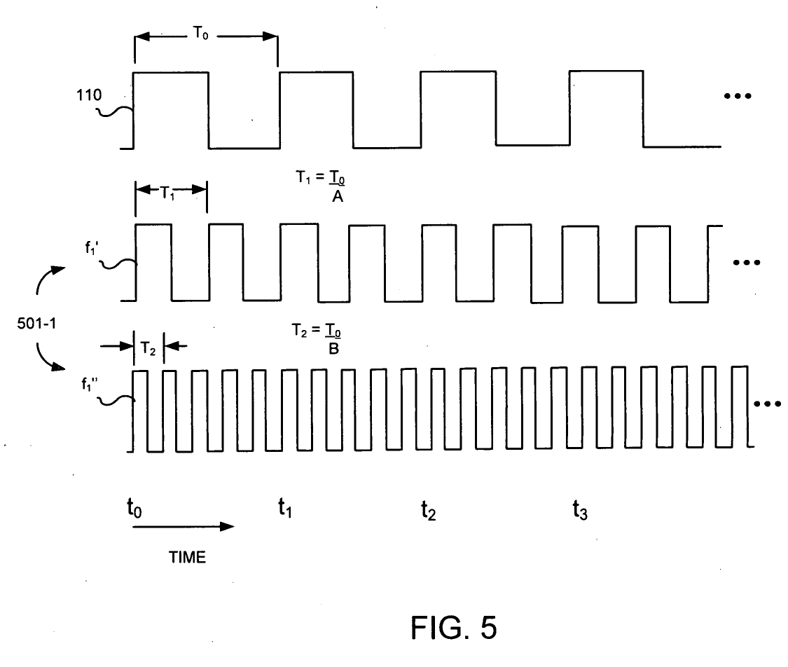

It will be appreciated by one of ordinary skill in the art that in some embodiments all clock frequencies f₁-fₘ are harmonically related because all are phase-locked to the common reference frequency 110 (f₀). In particular, any two clock frequencies in a single frequency control channel (e.g., clock frequencies f₁′ and f₁″ in frequency control channel 501-1) will be harmonically related. FIG. 5 illustrates how this harmonic relationship may be used to switch between a first clock frequency and a second clock frequency without halting the processing system 100. FIG. 5 depicts reference frequency 110 having frequency f₀ and period T₀=1/f₀, clock frequency f₁′=Af₀ and period T₁=T₀/A, and frequency f₁″=Bf₀ and period T₂=T₀/B. As shown in FIG. 5, the phase of clock frequency f₁′ will periodically align with the phase of clock frequency f₁″ (e.g., at times t₁, t₂, t₃, etc.) at time intervals corresponding to the lowest common multiples of T₁ and T₂. This time interval may be calculated, for example, by I/O controller 201 or the monitoring engine 220. Therefore, when a new operating state is commanded by the monitoring engine 200 in response to the processing demand, the switch from the first clock frequency (e.g., f₁′) to the second clock frequency (e.g., f₁″) may be timed to occur when the phases of the first clock frequency and the second clock frequency are aligned. If the phases of the first clock frequency and the second clock frequency are aligned when the frequencies are switched (e.g., by a multiplexer), there is no phase discontinuity in the processing system 100 and the frequencies may be switched without halting the processing system 100. In one embodiment, the ratio of the second clock frequency to the first clock frequency may be very large, approximately up to six orders of magnitude depending on the stability of the reference frequency 110. Alternatively, other ratios may be used.

Thus, a method of and an apparatus for on-demand power management have been described. It will be apparent from the foregoing description that aspects of the present invention may be embodied, at least in part, in software. That is, the techniques may be carried out in a computer system or other data processing system in response to its processor, such as microprocessor 101, executing sequences of instructions contained in a memory, such as programmable memory. In various embodiments, hardwired circuitry may be used in combination with software instructions to implement the present invention. Thus, the techniques are not limited to any specific combination of hardware circuitry and software or to any particular source for the instructions executed by the data processing system. For example, in some embodiments, the techniques may be carried out using firmware (e.g., embedded software). Alternatively, the techniques may be carried out using any combination of hardware, firmware, and software. In addition, throughout this description, various functions and operations may be described as being performed by or caused by software code to simplify description. However, those skilled in the art will recognize what is meant by such expressions are that the functions result from execution of the code by a processor or controller, such as microprocessor 101.

A machine-readable medium can be used to store software and data which when executed by a data processing system causes the system to perform various methods of the present invention. This executable software and data may be stored in various places including, for example, read-only memory (ROM) and programmable memory or any other device that is capable of storing software programs and/or data.

Thus, a computer-readable medium includes any mechanism that stores information in a form accessible by a machine (e.g., a computer, network device, personal digital assistant, manufacturing tool, any device with a set of one or more processors, etc.). For example, a computer-readable medium includes recordable/non-recordable media (e.g., read only memory (ROM); random access memory (RAM); magnetic disk storage media; optical storage media; flash memory devices; etc.); etc. In one embodiment, the computer-readable medium stores instruction therein that, when executed by a processing device, cause the processing device to perform the operations described herein.

It should be appreciated that references throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention. In addition, while the invention has been described in terms of several embodiments, those skilled in the art will recognize that the invention is not limited to the embodiments described. The embodiments of the invention can be practiced with modification and alteration within the scope of the appended claims. The specification and the drawings are thus to be regarded as illustrative instead of limiting on the invention.

What is claimed is:

1. A computer-implemented method, comprising:
providing a first operating voltage and a first clock frequency to a peripheral device, operating in a first operating state, wherein the peripheral device is coupled to an input-output (I/O) controller in a processing system with a parallel bus;
monitoring bus transactions on the parallel bus using a power manager, coupled to the parallel bus, to assess a current processing demand for the peripheral device; and
dynamically adjusting at least one of the first operating voltage or the first clock frequency in response to the current processing demand.

2. The method of claim 1, wherein monitoring comprises:
monitoring a control line between the I/O controller and the peripheral device to detect a data transfer request for a current bus transaction between the I/O controller and the peripheral device; and
determining whether the peripheral device is to operate in a second operating state to process the current bus transaction, wherein the second operating state corresponds to the current processing demand, and wherein dynamically adjusting comprises switching the peripheral device to operate in the second operating state to allow the peripheral device to process the current bus transaction, wherein the first operating state is a lower power state than the second operating state.

3. The method of claim 2, wherein monitoring the control line comprises monitoring the control line for at least one of the following signals: a chip select signal, an output enable signal, a write enable signal, or a busy signal.

4. The method of claim 1, wherein dynamically adjusting comprises:
adjusting the first operating voltage to a second operating voltage; and
adjusting the first clock frequency to a second clock frequency.

5. The method of claim 4, wherein adjusting the second clock frequency comprises:
generating the second clock frequency in response to the processing demand, wherein the second clock frequency is phase-locked to a reference frequency and phase-matched to the first clock frequency; and
switching from the first clock frequency to the second clock frequency without halting the processing system.

6. The method of claim 1, wherein dynamically adjusting comprises adjusting the first operating voltage to a second operating voltage.

7. The method of claim 6, wherein dynamically adjusting further comprises monitoring the voltage adjustment to determine when the operating voltage supplied to the peripheral device meets or exceeds a voltage threshold.

8. The method of claim 1, wherein dynamically adjusting comprises adjusting the first clock frequency to a second clock frequency.

9. The method of claim 2, further comprising delaying the current bus transaction from being sent to the peripheral device using the power manager, wherein the current bus transaction is delayed until the power manager finishes the adjusting.

10. The method of claim 9, wherein delaying the current bus transaction comprises notifying the I/O controller that the peripheral device is busy to pause the current bus transaction from being sent by the I/O controller.

11. The method of claim 10, wherein notifying the I/O controller comprises:
providing a busy signal to the I/O controller to delay the I/O controller from sending data for the current bus transaction to the peripheral device; and
releasing the busy signal when the power manager finishes adjusting the at least one of the first operating voltage or the first clock frequency.

12. The method of claim 11, further comprising determining that the operating voltage being supplied to the peripheral device meets or exceeds a voltage threshold to determine that the power manager finishes the adjusting.

13. The method of claim 1, wherein a plurality of parallel peripheral devices, including the peripheral device, are coupled to the I/O controller on the parallel bus, and wherein the monitoring comprises:
detecting a data transfer request for a current bus transaction between the I/O controller and one of the plurality of parallel peripheral devices;
determining whether the one parallel peripheral device is in an active state;
delaying the current bus transaction from being sent to the one parallel peripheral device by placing the I/O controller in a wait state for the current bus transaction;
transitioning the one parallel peripheral device to a second operating state from the first operating state, wherein the first operating state is a lower power state than the second operating state; and
initiating a device communication flow between the I/O controller and the one parallel peripheral device for the current bus transaction when the one parallel peripheral device is operating at the second operating state.

14. The method of claim 13, wherein the monitoring further comprises transitioning the one parallel peripheral device to the first operating state from the second operating state when the current bus transaction is completed.

15. The method of claim 13, wherein delaying the current bus transaction comprises asserting a busy signal to the parallel bus between the I/O controller and the one parallel peripheral device, and wherein initiating the device communication flow comprises releasing the busy signal.

16. The method of claim 13, wherein detecting the data transfer request for the current bus transaction comprises:
detecting a chip select signal for the one parallel peripheral device to decode which of the plurality of parallel peripheral device is addressed by the data transfer request; and
detecting at least one of a write enable signal or an output enable signal to determine a type of the data transfer request.

17. The method of claim 16, wherein transitioning the one parallel peripheral device to the second operating state comprises:
transitioning the one parallel peripheral device to the second operating state when the chip select signal and the write enable signal are detected; and
transitioning the one parallel peripheral device to a third operating state from the first operating state when the chip select signal and the output enable signal are detected, wherein the first operating state is a lower power state than the third operating state.

18. The method of claim 13, wherein transitioning the one parallel peripheral device to the second operating state comprises:
transitioning the one parallel peripheral device to the second operating state when the current bus transaction is a read operation; and
transitioning the one parallel peripheral device to a third operating state from the first operating state when the current bus transaction is a write operation, wherein the first operating state is a lower power state than the third operating state.

19. An apparatus, comprising:
a first bus interface coupled to a parallel bus between an input-output (I/O) controller and a parallel peripheral device in a processing system, wherein the parallel peripheral device is operated at a first operating state; and
a monitoring engine coupled to the first bus interface to monitor bus transactions on the parallel bus to assess a current processing demand for the parallel peripheral device, and to dynamically adjust at least one of a first operating voltage or a first clock frequency, supplied to the parallel peripheral device in the first operating state, in response to the current processing demand.

20. The apparatus of claim 19, wherein the monitoring engine is configured to detect a data transfer request for a current bus transaction between the I/O controller and the parallel peripheral device, to determine whether the parallel peripheral device is to operate in a second operating state for the current bus transaction, and to switch the parallel peripheral device to operate in the second operating to allow the parallel peripheral device to process the current bus transaction, wherein the first operating state is a lower power state than the second operating state.

21. The apparatus of claim 20, further comprising an adjustable voltage regulator coupled to receive a signal from the monitoring engine to adjust the first operating voltage supplied to the parallel peripheral device to a second operating voltage when the monitoring engine switches the parallel peripheral device to the second operating state.

22. The apparatus of claim 20, further comprising a multiplexer coupled to the monitoring engine to adjust the first clock frequency to a second clock frequency when the monitoring engine switches the parallel peripheral device to the second operating state.

23. The apparatus of claim 20, further comprising a feedback circuit, coupled between the parallel peripheral device and the monitoring engine, to determine when the operating voltage supplied to the parallel peripheral device meets or exceeds a voltage threshold.

24. The apparatus of claim 21, further comprising a feedback circuit, coupled between the parallel peripheral device and the monitoring engine, wherein the feedback circuit comprises an comparator having a non-inverting terminal coupled to a voltage line between the adjustable voltage regulator and the parallel peripheral device, an inverting terminal coupled to receive a voltage threshold from the monitoring engine, and an output terminal to send a signal to the monitoring engine to indicate that the operating voltage supplied to the parallel peripheral device on the voltage line meets or exceeds the adjustable voltage threshold when switching from the first operating voltage to the second operating voltage.

25. The apparatus of claim 22, wherein the monitoring engine comprises a phase-locked loop circuit coupled to provide a locked signal to the monitoring engine to indicate when the second frequency is locked to a reference frequency.

26. A computer-implemented method, comprising:
monitoring bus transaction using a power manager disposed on a parallel bus among a plurality of parallel peripheral devices and a host processing device in a processing system;
monitoring the bus transactions on the parallel bus to assess a current processing demand for at least one of the plurality of parallel peripheral devices, wherein the current processing demand correlates to an operating state of the at least one parallel peripheral device; and
compensating for the current processing demand by dynamically scaling at least one of an operating voltage or a clock frequency supplied to the at least one parallel peripheral device to meet the current processing demand.

27. The method of claim 26, wherein the at least one parallel peripheral device is operating at a first clock frequency, and wherein dynamically scaling the clock frequency supplied to the at least one parallel peripheral device comprises:
generating a second clock frequency in response to the current processing demand, wherein the second clock frequency is phase-matched to the first clock frequency; and
switching from the first clock frequency to the second clock frequency without halting the processing system.

28. The method of claim 26, wherein the at least one parallel peripheral device is operating at a first voltage, and wherein dynamically scaling the operating voltage supplied to the at least one parallel peripheral device comprises:
generating a second voltage in response to the current processing demand; and
switching from the first voltage to the second voltage without halting the processing system.
